(19) United States
(12) Patent Application Publication
(10) Pub. No.: US 2010/0131843 A1
(43) Pub. Date: May 27, 2010

(54) Transforming Business Process Data to Generate a Virtual World Client for Human Interactions

(75) Inventors: Matthias Hub, Stuttgart (DE); Fabienne Marquart, Stuttgart (DE)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/323,987

(22) Filed: Nov. 26, 2008

(51) Int. Cl. G06F 3/048

(52) U.S. Cl. 715/706

(57) ABSTRACT

A method of building artifacts that are used in a virtual world is provided. The method includes: parsing data of a business process; extracting at least one of input and output data from the parsed data; building a business artifact based on the at least one of input and output data; and associating the business artifact with the virtual world.

### BACKGROUND

This invention relates to methods, systems, and computer program products for integrating a business process with a virtual world.

A virtual world is a computer-based, simulated environment that allows users to interact via avatars. The avatars can be depicted as textual, two-dimensional, or three-dimensional representations, although other forms are possible. Some, but not all, virtual worlds allow for multiple users.

In a virtual world, the computer presents perceptual stimuli to the user, who in turn, can manipulate elements of the modeled world and thus, experience telepresence to a certain degree. Such modeled worlds may appear similar to the real world or instead depict fantasy worlds. The modeled world may simulate rules based on the real world or some hybrid fantasy world. Example rules may include gravity, topography, locomotion, real-time actions, and communications. It would be desirable to implement rules of a predefined process as one or more rules of a virtual world.

### SUMMARY

Accordingly, a method of building artifacts that are used in a virtual world is provided. The method comprises: parsing data of a business process; extracting at least one of input and output data from the parsed data; building a business artifact based on the at least one of input and output data; and associating the business artifact with the virtual world.

Additional features and advantages are realized through the techniques of the present disclosure. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The drawings described herein are for illustration purpose only and are not intended to limit the scope of the present disclosure in any way. It should be understood that throughout the drawings, corresponding reference numerals indicate like or corresponding parts and features.

FIG. 1 is a functional block diagram illustrating a computing system that includes a virtual world client builder in accordance with an exemplary embodiment.

FIG. 2 is a dataflow diagram illustrating the virtual world client builder of FIG. 1 in accordance with an exemplary embodiment.

FIG. 3 is a flowchart illustrating a client building method that can be performed by the virtual world client builder of FIG. 1 in accordance with an exemplary embodiment.

### DETAILED DESCRIPTION

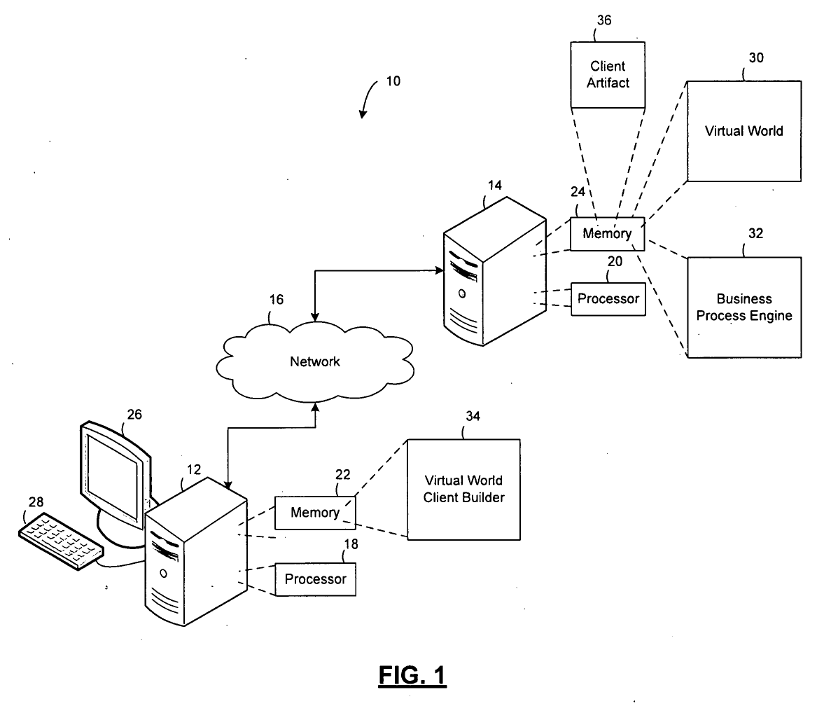

Turning now to the drawings in greater detail, it will be seen that in FIG. 1 a computing system 10 includes one or more computers 12, 14 that are communicatively coupled via a network 16. As can be appreciated, the network 16 can be any single type or combination type of known networks including, but not limited to, a wide area network (WAN), a local area network (LAN), a global network (e.g. Internet), a virtual private network (VPN), and an intranet.

The one or more computers 12, 14 include a processor 18, 20 respectively and one or more data storage devices 22, 24 respectively. The processor 18, 20 can be any custom made or commercially available processor, a central processing unit, an auxiliary processor among several processors associated with the computer 12, 14, a semiconductor based microprocessor, a macroprocessor, or generally any device for executing instructions. The one or more data storage devices 22, 24 can be at least one of the random access memory, read only memory, a cash, a stack, or the like which may temporarily or permanently store electronic data. As shown, the computer 12 is a desktop computer and the computer 14 is a server. As can be appreciated, the computers 12, 14 are not limited to the present example and can include, but are not limited to, a desktop computer, a laptop, a workstation, a portable handheld device, a server, or any device that includes a processor and memory.

As shown, the computer 12 is associated with a display device 26 and one or more input devices 28 that may be used by a user to communicate with the computer 12. As can be appreciated, such input devices 28 may include, but are not limited to, a mouse, a keyboard, and a touchpad.

According to an exemplary embodiment, one or more of the computers 12, 14 includes a virtual world 30 and a business process engine 32. The virtual world 30 includes data and software instructions for depicting space virtually. As can be appreciated, the space can be any space related to a business process. In various embodiments, the virtual world provides a shared space that is accessible by one or more users, where the access can be in real-time, can be provide for cohabitation of the multiple users, and can allow interaction between the multiple users.

The business process engine 32 includes data and software instructions for processing business tasks or rules of a business process. As can be appreciated, the business process can include, but is not limited to, a business transaction, such as a purchase, a sale, an order, etc.

According to an exemplary embodiment, one or more of the computers 12, 14 includes a virtual world client builder 34. The virtual world client builder 34 builds business process client artifacts 36 for use in the virtual world 30 based on the predefined business process. The business process client artifacts 36, upon completion can be stored to the data storage device 24 of the computer 14. Based on an interaction with the business process client artifacts 36 within the virtual world 30, the business process engine 32 executes an associated task or rule.

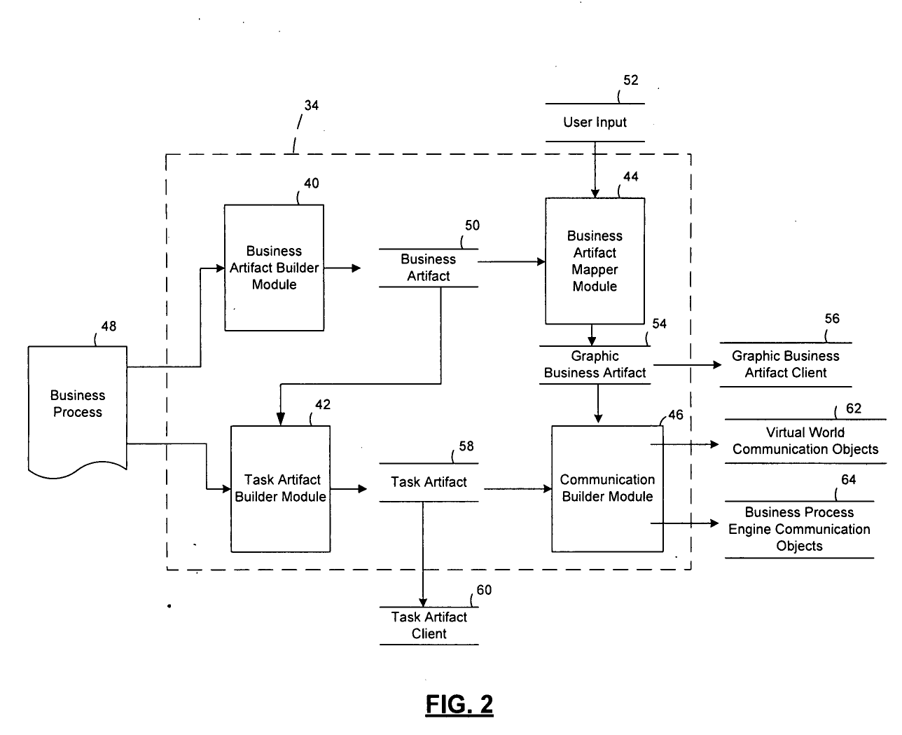

Referring now to FIG. 2, a dataflow diagram illustrates the virtual world client builder 34 in more detail in accordance with an exemplary embodiment. The virtual world client builder 34 can include one or more sub-modules and datastores. As can be appreciated, the sub-modules can be implemented as software, hardware, firmware and/or other suitable components that provide the described functionality. As can be appreciated, the sub-modules shown in FIG. 2 can be combined and/or further partitioned to similarly build business process client artifacts 36 (FIG. 1) for use in the virtual world 30 (FIG. 1). In this example, the virtual world client builder 34 includes a business artifact builder module 40, a task artifact builder module 42, a business artifact mapper module 44, and a communication builder module 46.

The business artifact builder module 40 receives as input a business process 48. In various embodiments, the business process 48 is defined by business rules and business objects. The business objects include data associated with the business; and business rules include operations that change the process behavior based on the data of the business objects. As can be appreciated, the business process 48 can be any process including rules and objects. For exemplary purposes, the disclosure will be discussed in the context of a business process.

The business artifact builder module 40 parses the business process 48 based on a predefined business grammar. Based on the parsed data, the business artifact builder module 40 extracts input data and output data of the business process 48 and builds business artifacts 50. The business artifacts 50 can include, for example, merchandise, documents, products, goods, and services.

The business artifact mapper module 44 receives as input the business artifacts 50 and optionally, user input 52. The user input 52 can be generated based on a user's communication with a user interface of the virtual world client builder 34 via the input devices 28 (FIG. 1). Based on the user input 52, the business artifact mapper module 44 maps each of the business artifacts 50 to a graphical artifact, for example, a three-dimensional (3D) business artifact or a simple two-dimensional (2D) business artifact. In various embodiments, the business artifact mapper module 44 can automatically map each of the business artifacts 50 to a graphical artifact based on predefined mapping instructions thus, without user input 52, or by using a combination of the predefined mapping instructions and the user input 52. The graphic business artifact 54 is provided for use by the virtual world 30 as a graphic business artifact client 56.

The task artifact builder module 42 receives as input the business process 48 and the business artifacts 50. The task artifact builder module 42 parses the business process 48 based on a predefined business grammar. Based on the parsed data, the task artifact builder module 42 extracts information relating to tasks of the business process 48, associates the business artifacts 50 with the tasks, and builds task artifacts 58. The task artifacts 58 can include, for example, operations to be performed on the business artifacts 50 such as, for example, a sale, a purchase, an order, etc. In various embodiments, the task artifacts 58 are the tasks that involve human interaction (human tasks) in the business process. The task artifacts 58 are provided for use by the virtual world 30 (FIG. 1) as task artifact clients 60.

The communication builder module 46 receives as input the task artifacts 58 and the business artifacts 50. The communication builder module 46 builds communication artifacts for use by the virtual world 30 (FIG. 1) and the business process engine 32 (FIG. 2). The virtual world communication artifacts 62 permit interaction with the business artifact clients 56 and the task artifact clients 60 within the virtual world 30 (FIG. 1). The business process communication artifacts 64 permit execution of the task artifacts by the business process engine 32 (FIG. 1) based on the interaction with the business artifact clients 56.

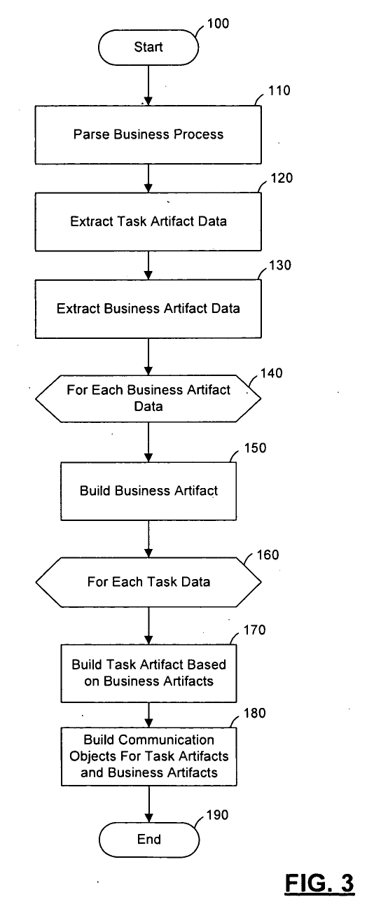

Referring now to FIG. 3 and with continued reference to FIG. 2, a client builder method that can be performed by the virtual world client builder 34 of the present disclosure is shown in more detail in accordance with an exemplary embodiment. As can be appreciated in light of the disclosure, the order of operation within the method is not limited to the sequential execution as illustrated in FIG. 3, but may be performed in one or more varying orders as applicable and in accordance with the present disclosure. As can be appreciated, one or more steps of the methods can be added or removed without altering the spirit of the method.

In this example, the method may begin at 100. The business process 48 is parsed at process block 110. The task data is extracted from the parsed data at process block 120; and the input and output data is extracted as business artifact data from the parsed data at process block 130. For each input and output data of the business artifact data at process block 140, a business artifact 50 is built at process block 150 and mapped to a graphic business artifact 54 at process block 160. For each task of the task data at process block 160, the task artifact 58 is built based on the business artifacts 50 at process block 170. Communication artifacts 62, 64 are built for the business artifacts 50 and the task artifacts 58 at process block 180. Thereafter, the method may end at process block 190.

The capabilities of the present invention can be implemented in software, firmware, hardware or some combination thereof.

As can be appreciated, the flowcharts and block diagrams in the FIGS illustrate the architecture, functionality, and operation of the possible implementations of systems, methods, and computer program products according to various embodiments of the present disclosure. In this regards, each block in the flowchart or block diagrams may represent a module, segment, or a portion of code which comprises one or more executable instructions for implementing the specified logical functions. It should also be noted that, in some alternative implementations, the functions noted in the block may occur out of the order noted in the FIGS. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts can be implemented by special purpose hardware-based systems that perform the specified functions or acts, or combinations of special purpose hardware and computer instructions.

As one example, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or provided separately.

Additionally, at least one program storage device readable by a machine, tangibly embodying at least one program of instructions executable by the machine to perform the capabilities of the present disclosure can be provided.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise process in a suitable manner, if necessary, and then stored in a computer memory. In the context of this disclosure, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an artifact oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

While a preferred embodiment has been described, it will be understood that those skilled in the art, both now and in the future, may make various improvements and enhancements which fall within the scope of the claims which follow. These claims should be construed to maintain the proper protection for the disclosure first described.

The terminology used herein is for the purpose of describing particular embodiments only and is not intended to be limiting of the invention. As used herein, the singular forms “a”, “an” and “the” are intended to include the plural forms as well, unless the context clearly indicates otherwise. The corresponding structures, features, materials, acts, and equivalents of all means or step plus function elements in the claims below are intended to include any structure, material, or act for performing the function in combination with other claimed elements as specifically claimed. The disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of building artifacts that are used in a virtual world, the method comprising:
parsing data of a business process;
extracting at least one of input and output data from the parsed data;
building a business artifact based on the at least one of input and output data; and
associating the business artifact with the virtual world.

2. The method of claim 1 further comprising:
extracting task data from the parsed data;
building a task artifact based on the task data and the business artifact; and
associating the task artifact with the virtual world.

3. The method of claim 1 wherein the building comprises mapping the business artifact to a graphic artifact.

4. The method of claim 3 wherein the graphic artifact includes at least one of two and three dimensions.

5. The method of claim 3 wherein the mapping is performed based on user input entered via a user interface.

6. The method of claim 1 further comprising building communication data that interfaces the business artifact with the virtual world.

7. The method of claim 1 further comprising building communication data that interfaces the business artifact with a business process engine.

8. The method of claim 1 wherein the parsing and the extracting is automatically performed based on predefined rules.

9. A system for building artifacts that are used in a virtual world, the method comprising:
a business artifact builder module that parses data of a business process, that extracts at least one of input data and output data from the parsed data, and that builds a business artifact based on the at least one of input data and output data; and
a communication builder module that associates the business artifact with the virtual world.

10. The system of claim 9 further comprising a task artifact builder module that extracts task data from the parsed data, that builds a task artifact based on the task data and the business artifact, and that associates the task artifact with the virtual world.

11. The system of claim 9 wherein the business artifact builder module maps the business artifact to a graphic artifact.

12. The system of claim 11 wherein the business artifact builder module maps the business artifact based on user input entered via a user interface.

13. The system of claim 9 wherein the graphic artifact includes at least one of two and three dimensions.

14. The system of claim 9 wherein the communication builder module builds communication data that interfaces the business artifact with the virtual world.

15. The system of claim 9 wherein the communication builder module builds communication data that interfaces the business artifact with a business process engine.

16. The system of claim 9 wherein the business artifact builder module automatically performs the parsing and the extracting based on predefined rules.
